(19) United States
(12) Patent Application Publication
(10) Pub. No.: US 2021/0286223 A1
(43) Pub. Date: Sep. 16, 2021

(54) DISPLAY PANEL AND DISPLAY MODULE

(71) Applicant: Shenzhen China Star Optoelectronics Semiconductor Display Technology Co., Ltd., Shenzhen, Guangdong (CN)

(72) Inventor: Wu CAO, Shenzhen, Guangdong (CN)

(21) Appl. No.: 16/759,344

(22) PCT Filed: Apr. 7, 2020
(86) PCT No.: PCT/CN2020/083511

§ 371 Date: Apr. 26, 2020

(30) Foreign Application Priority Data
Mar. 13, 2020 (CN) 202010176181.9

(51) Int. Cl. G02F 1/1362; G06F 3/041; G06F 3/044

(52) U.S. Cl. CPC G02F 1/136286; G02F 1/136227; G02F 2201/121; G06F 3/0443; G02F 2001/136222; G06F 3/0412

(57) ABSTRACT

The disclosure provides a display panel and a display module. A first base plate of the display panel includes a first substrate, a driving circuit layer, a first common electrode layer, and a plurality of electrical connectors. A second base plate of the display panel includes a second substrate and a second common electrode layer. The display panel further includes a touch component including a touch electrode layer and a touch wire, the touch electrode layer is disposed between the second substrate and the second common electrode layer, and the touch electrode layer is electrically connected to the touch wire by the electrical connectors.

### FIELD

The present disclosure relates to the field of display, and more particularly, relates to a display panel and a display module.

### BACKGROUND

Liquid crystal displays (LCDs), which are flat display devices that display an image by switching liquid crystals to adjust light intensity of a backlight source, have been widely used.

Typically, a vertical alignment mode is used in conventional large-scale LCD panels, and such panels usually realize a touch control function by an add-on touch technology. However, to reduce a thickness of a module, an in-cell touch technology is increasingly used in the large-scale LCD panels.

In-cell touch devices are usually disposed in an array substrate of the large-scale LCD panels, and the array substrate is set to be a light-emitting side to ensure touch sensitivity. However, a lot of signal wires are disposed in the array substrate, which increases an amount of ambient light being reflected when the ambient light shines on the signal wires, affecting display effect of the panels.

Therefore, it is necessary to provide a display panel to solve the above technical problem.

### SUMMARY

The present disclosure provides a display panel and a display module to solve a technical problem: in conventional large-scale panels, light emitted from a backlight source is overly reflected by an array substrate.

The present disclosure provides a display panel, including a first base plate, a second base plate disposed opposite to the first base plate, and a liquid crystal layer disposed between the first base plate and the second base plate.

The first base plate includes a first substrate, a driving circuit layer disposed on the first substrate, and a first common electrode layer and a plurality of electrical connectors, which are disposed on the driving circuit layer.

The second base plate includes a second substrate and a second common electrode layer disposed on the second substrate.

The display panel further includes a touch component. The touch component includes a touch electrode layer disposed between the second substrate and the second common electrode layer and a touch wire disposed in the driving circuit layer, and the touch control layer is electrically connected to the touch wire by the electrical connectors.

In the display panel provided by the present disclosure, the driving circuit layer includes a gate layer disposed on the first substrate and a source/drain layer disposed on the gate layer.

The touch wire and at least one of the gate layer or the source/drain layer are disposed on a same layer.

In the display panel provided by the present disclosure, the driving circuit layer further includes a light-shading metal layer disposed between the first substrate and the gate layer.

The touch wire and at least one of the gate layer, the source/drain layer, or the light-shading metal layer are disposed on a same layer.

In the display panel provided by the present disclosure, the second substrate includes at least two first recesses, one of the at least two first recesses corresponds to one of the electrical connectors, and the at least two first recesses penetrate the second common electrode layer. An insulating disposed between the second common electrode layer and the touch electrode layer, thereby exposing a portion of the touch electrode layer.

The electrical connectors are electrically connected to the touch electrode layer by the at least two first recesses.

In the display panel provided by the present disclosure, a number of the at least two first recesses is less than or equal to a number of the electrical connectors.

In the display panel provided by the present disclosure, the display panel further includes a color filter layer disposed in the first base plate or in the second base plate.

The color filter layer is disposed on a first side of the touch electrode layer near the second common electrode layer or on a second side of the touch electrode layer away from the second common electrode.

In the display panel provided by the present disclosure, each of the electrical connectors includes a first connector which is a conductive material.

The touch electrode layer is electrically connected to the touch wire in the driving circuit layer by the first connector.

In the display panel provided by the present disclosure, each of the electrical connectors includes a first connector and a second connector, the first connector is a conductive material, and the second connector is an insulating material.

The second connector is disposed on a surface of the first connector or in the first connector.

The touch electrode layer is electrically connected to the touch wire in the driving circuit layer by the second connector.

In the display panel provided by the present disclosure, the touch electrode layer includes at least two touch electrodes distributed in an array manner, and an area of any one of the at least two touch electrodes ranges from 9 mm² to 100 mm².

In the display panel provided by the present disclosure, a plurality of first intervals between two adjacent electrical connectors are equal in a first direction of the display panel.

The first intervals and the second intervals are not equal.

The present disclosure further provides a display module, including a display panel, and a polarizer layer and a cover plate layer, which are disposed on the display panel, the display panel includes a first base plate, a second base plate disposed opposite to the first base plate, and a liquid crystal layer disposed between the first base plate and the second base plate.

The first base plate includes a first substrate, a driving circuit layer disposed on the first substrate, and a first common electrode layer and a plurality of electrical connectors, which are disposed on the driving circuit layer.

The second base plate includes a second substrate and a second common electrode layer disposed on the second substrate.

The display panel further includes a touch component. The touch component includes a touch electrode layer disposed between the second substrate and the second common electrode layer and a touch wire disposed in the driving circuit layer, and the touch control layer is electrically connected to the touch wire by the electrical connectors.

In the display module provided by the present disclosure, the driving circuit layer includes a gate layer disposed on the first substrate and a source/drain layer disposed on the gate layer.

The touch wire and at least one of the gate layer or the source/drain layer are disposed on a same layer.

In the display module provided by the present disclosure, the driving circuit layer further includes a light-shading metal layer disposed between the first substrate and the gate layer.

The touch wire and at least one of the gate layer or the source/drain layer are disposed on a same layer.

In the display module provided by the present disclosure, the second substrate includes at least two first recesses, one of the at least two first recesses corresponds to one of the electrical connectors, and the at least two first recesses penetrate the second common electrode layer. An insulating disposed between the second common electrode layer and the touch electrode layer, thereby exposing a portion of the touch electrode layer.

The electrical connectors are electrically connected to the touch electrode layer by the at least two first recesses.

In the display module provided by the present disclosure, a number of the at least two first recesses is less than or equal to a number of the electrical connectors.

In the display module provided by the present disclosure, the display panel further includes a color filter layer disposed in the first base plate or in the second base plate.

The color filter layer is disposed on a first side of the touch electrode layer near the second common electrode layer or on a second side of the touch electrode layer away from the second common electrode.

In the display module provided by the present disclosure, each of the electrical connectors includes a first connector which is a conductive material.

The touch electrode layer is electrically connected to the touch wire in the driving circuit layer by the first connector.

In the display module provided by the present disclosure, each of the electrical connectors includes a first connector and a second connector, the first connector is a conductive material, and the second connector is an insulating material.

The second connector is disposed on a surface of the first connector or in the first connector.

The touch electrode layer is electrically connected to the touch wire in the driving circuit layer by the second connector.

In the display module provided by the present disclosure, the touch electrode layer includes at least two touch electrodes distributed in an array manner, and an area of any one of the at least two touch electrodes ranges from 9 mm² to 100 mm².

In the display module provided by the present disclosure, a plurality of first intervals between two adjacent electrical connectors are equal in a first direction of the display panel.

The first intervals and the second intervals are not equal.

Regarding the beneficial effects: in the present disclosure, a touch electrode layer is disposed on a light-emitting side of a display panel rather than on a driving circuit layer, and a touch wire is disposed on the driving circuit layer. Therefore, fewer metal wires are disposed on the light-emitting side, an amount of ambient light being reflected is reduced, and display effect of the display panel is improved.

### DESCRIPTION OF DRAWINGS

FIG. 1 is a first structural view showing a display panel provided by the present disclosure.

FIG. 2 is a second structural view showing the display panel provided by the present disclosure.

FIG. 3 is a third structural view showing the display panel provided by the present disclosure.

FIG. 4 is a fourth structural view showing the display panel provided by the present disclosure.

### DETAILED DESCRIPTION

Embodiments are further described below in detail with reference to accompanying drawings to make objectives, technical solutions, and effects of the present disclosure clearer and more precise. It should be noted that described embodiments are merely used to construct the present disclosure and are not intended to limit the present disclosure.

In-cell touch devices are usually disposed in an array substrate of large-scale LCD panels, and the array substrate is set to be a light-emitting side to ensure touch sensitivity. However, a lot of signal wires are disposed in the array substrate, which increases an amount of ambient light being reflected when the ambient light shines on the signal wires, leading to display effect of the panels being affected. The present disclosure provides following technical solutions to solve the above technical problem.

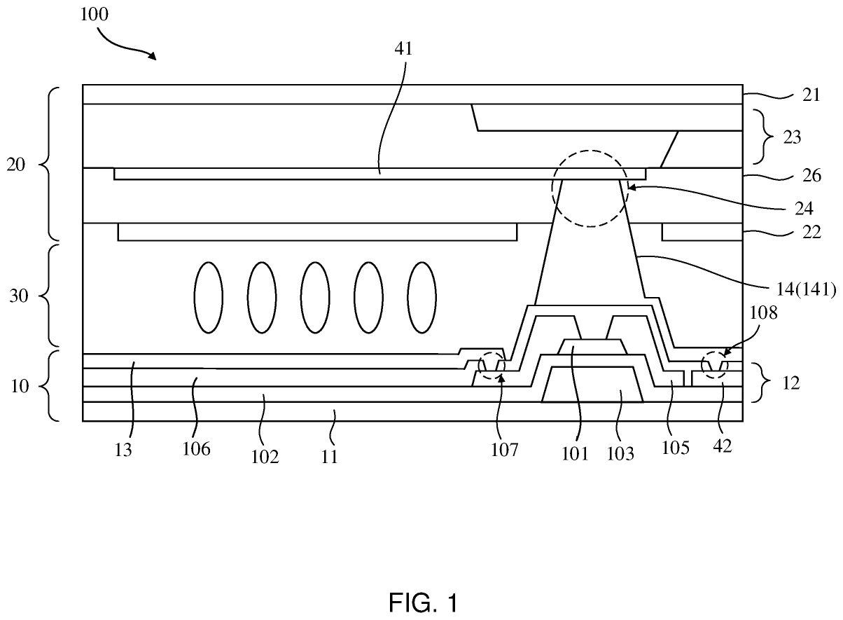

Please refer to FIGS. 1 to 4, the present disclosure provides a display panel 100, including a first base plate 10, a second base plate 20 disposed opposite to the first base plate 10, and a liquid crystal layer 30 disposed between the first base plate 10 and the second base plate 20.

The first substrate 10 includes a first substrate 11, a driving circuit layer 12 disposed on the first substrate 11, and a first common electrode layer 13 and a plurality of electrical connectors 14, which are disposed on the driving circuit layer 12.

The second base plate 20 includes a second substrate 21 and a second common electrode layer 22 disposed on the second substrate 21.

The display panel 100 further includes a touch component. The touch component includes a touch electrode layer 41 disposed between the second substrate 21 and the second common electrode layer 22 and a touch wire 42 disposed in the driving circuit layer 12. The touch control layer 41 is electrically connected to the touch wire 42 by the electrical connectors 14.

In the present disclosure, the touch electrode layer 41 is disposed on a light-emitting side of the display panel 100 rather than on the driving circuit layer 12, and the touch wire 42 is disposed on the driving circuit layer 12. Therefore, fewer metal wires are disposed on the light-emitting side, an amount of ambient light being reflected is reduced, and display effect of the display panel is improved.

The technical solutions provided by the present disclosure are described with reference to specific embodiments.

Please refer to FIG. 1, the first base plate 10 may be an array substrate, and the second base plate 20 may be a color filter substrate. The first substrate 11 and the second substrate 21 may be rigid substrates or flexible substrates. When the first substrate 11 and the second substrate 21 are rigid, materials thereof may be glass or quartz. When the first substrate 11 and the second substrate 21 are flexible substrates, materials thereof may be polyimide. In the LCD panel 100, the above substrates are generally rigid substrates, and are not described here in detail.

The driving circuit layer 12 includes a plurality of thin film transistors (TFTs). The TFTs may be etch-stop-layer TFTs, back-channel-etch TFTs, or top-gate TFTs, but are not limited thereto. For example, bottom-gate TFTs may include a gate layer 103 disposed on the first substrate 11, a gate insulating layer 102 disposed on the gate layer 103, an active layer 101 disposed on the gate insulating layer 102, a source/drain layer 105 disposed on the active layer 101, and a passivation layer 106 disposed on the source/drain layer 105.

In the present embodiment, the first common electrode is electrically connected to the source/drain layer 105 by a first through hole 107 of the passivation layer 106. The first common electrode layer 13, also called a pixel electrode layer, is configured to provide a first voltage to control orientations of liquid crystal molecules.

In the present embodiment, a material of the first common electrode layer 13 may be indium tin oxide (ITO).

In the present embodiment, the display panel 100 further includes a supporting component disposed on the array substrate.

In the present embodiment, the supporting component includes a first supporting layer and a second supporting layer (not shown). A thickness of the first supporting layer is greater than that of the second supporting layer. The first supporting layer is in contact with the second base plate 20.

In the present embodiment, the supporting component may be made of an organic material.

In the present embodiment, a portion of the first supporting layer may be formed from the electrical connectors 14.

In the present embodiment, the display panel 100 further includes a color filter layer 23, which is disposed in the first base plate 10 or the second base plate 20. When the color filter layer 23 is disposed in the second base plate 20, the color filter layer 23 is disposed on a first side of the touch electrode layer 41 near the second common electrode layer 22 or on a second side of the touch electrode layer 41 away from the second common electrode 22.

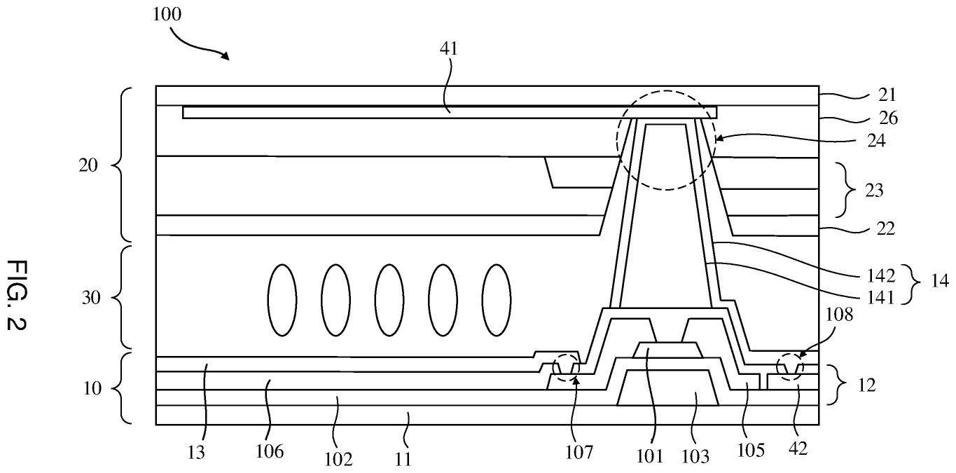

Take a normal color filter substrate as an example. As shown in FIG. 1, the color filter layer 23 is disposed between the touch electrode layer 41 and the second substrate 21. As shown in FIG. 2, the color filter layer 23 is disposed between the insulating layer 26, which is disposed in the second base plate 20, and the second common electrode.

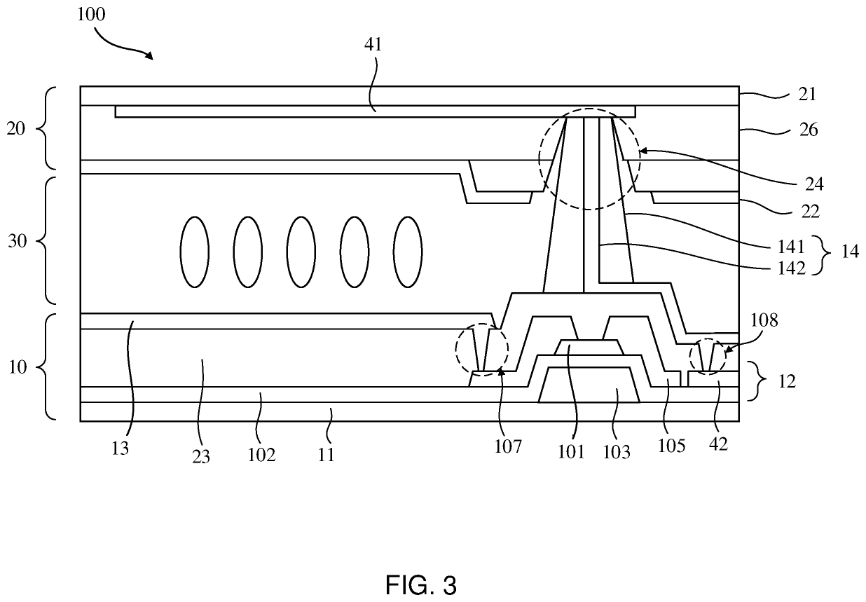

As shown in FIG. 3 in accordance with FIG. 1 and FIG. 2, the color filter layer 23 may also be disposed on the array substrate. In the present embodiment, an alignment error between the first base plate 10 and the second base plate 20 may be prevented, thereby improving quality of the display panel.

In the present embodiment, the first common electrode layer 13 is configured to provide a second voltage to control orientations of liquid crystal molecules. The second voltage is constant. The display panel 100 adjusts an amount of the first voltage to change a potential difference between two sides of the liquid crystal layer 30, thereby changing orientation directions of the liquid crystal molecules.

In the present embodiment, a material of the second common electrode layer 22 may be ITO.

Please refer to FIG. 1 and FIG. 2, the second base plate 20 further includes at least two first recesses 24.

In the present embodiment, one of the at least two first recesses 24 corresponds to one of the electrical connectors 14. The at least two first recesses penetrate the second common electrode layer 22 and the insulating layer 26 disposed between the second common electrode layer 22 and the touch electrode layer 41, thereby exposing a portion of the touch electrode layer 41. The electrical connectors 14 are electrically connected to the touch electrode layer 41 by the at least two first recesses 24.

In the present embodiment, a number of the at least two first recesses 24 is less than or equal to a number of the electrical connectors 14.

Because the second common electrode layer 22 is disposed in a planar manner, a voltage (IR) drop inevitably occurs on a portion of the second common electrode layer 22 due to capacitors and resistors when signals are transmitted. Therefore, the display panel will be abnormal. A portion of the electrical connectors 14 is directly connected to the second common electrode layer 22, thereby reducing an entire resistance of the second common electrode layer 22.

Alternatively, one of the electrical connectors 14 is connected to a constant power supply by a predetermined metal wire, thereby further ensuring voltage stability of the second common electrode layer 22, and ensuring display effect of the display panel.

For example, as shown in FIG. 1, one of the at least two recesses 24 penetrates the second common electrode layer 22 and the insulating layer 26. For example, as shown in FIG. 2, one of the at least two recesses 24 penetrates the second common electrode layer 22, the insulating layer 26, and the color filter layer 23. One of the electrical connectors 14 is connected to the exposed touch electrode layer 41 by one of the at least two recesses 24.

Shown in FIG. 1 and FIG. 2 are respectively two embodiments. Because the recess 24 in FIG. 2 is deeper than that in FIG. 1, a manufacturing process of the recess 24 in FIG. 2 is more complicated than that in FIG. 1. Therefore, a technical solution in FIG. 1 is better than that in FIG. 2.

In addition, as shown in FIG. 3, the color filter layer 23 is disposed on the array substrate, and a depth of the recess 24 in FIG. 3 is equal to that in FIG. 2. However, because the color filter layer 23 is disposed on the array substrate, a flatness of the array substrate in FIG. 3 is better than that in FIG. 1 and FIG. 2. As a result, if manufacturing conditions permit, a technical solution in FIG. 3 is better than that in FIG. 1 and FIG. 2.

Furthermore, in FIG. 3, the color filter layer 23 replaces the original passivation layer 106, thereby reducing a thickness of the display panel 100 without affecting a surface flatness of the array substrate.

Please refer to FIG. 1, each of the electrical connectors 14 includes a first connector 141, and the touch electrode layer 41 is electrically connected to the touch wire 42 in the driving circuit layer 12 by the first connector 141. The first connector 141 is a conductive material. In the present embodiment, the first connector 141 may be a supporting structure of the display panel 100, and may also be an electrical connector of the touch electrode layer 41.

Please refer to FIG. 2, each of the electrical connectors 14 includes the first connector 141 and a second connector 142. The first connector 141 is a conductive material, and the second connector 142 is an insulating material.

In the present embodiment, the second connector 142 is disposed on a surface of the first connector 141. The first connector 141 and a supporting component may be formed in a same process, and the second connector 142 and the first common electrode layer 13 may be formed in a same process.

Please refer to FIG. 3, the second connector 142 may be disposed in the first connector 141, thereby preventing failure of the liquid crystal molecules due to a direct contact between a metal layer and the liquid crystal layer 30. As shown in FIG. 2 and FIG. 3, the touch electrode layer 41 is electrically connected to the touch wire 42 in the driving circuit layer 12 by the second connector 142.

In the present embodiment, the electrical connectors 14 may be disposed in a non-display area of the display panel 100.

In the present embodiment, one of the electrical connectors 14 is electrically connected to the touch wire 42 by a second through hole 108.

In the above embodiments, electrical connectors as shown in FIG. 1 to FIG. 3 may also be used in other structures, which is not described here in detail.

In the display panel 100 provided by the present disclosure, the driving circuit layer 12 includes two metal layers, namely, the gate layer 103 disposed on the first substrate 11 and the source/drain layer 105 disposed on the gate layer 103. The touch wire 42 and at least one of the gate layer 103 or the source/drain layer 105 are disposed on a same layer.

For example, please refer to the technical solutions as shown in FIG. 1 to FIG. 3, the touch wire 42 and the source/drain layer 105 are disposed on a same layer. The touch wire 42 and a source/drain of the source/drain layer 105 may be formed in a same process. When the touch wire 42 and the gate late 103 are formed on a same layer, the touch wire 42 needs to bypass a plurality of scan wires that are horizontally disposed. Alternatively, the touch wire 42 may be formed from the two metal layers which are in a side-by-side configuration, thereby reducing resistance of the touch wire 42, and increasing sensitivity of touch signals.

In the above embodiments, the driving circuit layer 12 may also include a light-shading metal layer (not shown) disposed between the first substrate 11 and the gate layer 103. The touch wire 42 and at least one of the gate layer 103, the source/drain layer 105, or the light-shading metal layer are disposed on a same layer. An implemented method of the present embodiment is same as the above embodiments, and is not described here.

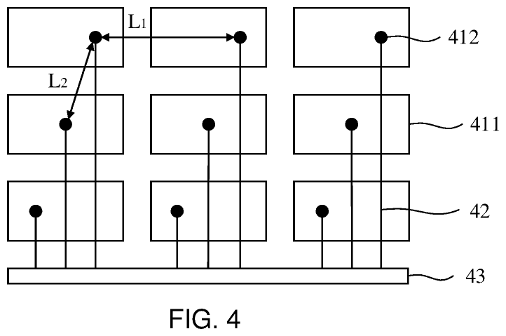

Please refer to FIG. 4, the touch electrode layer 41 includes at least two touch electrodes 411 distributed in an array manner. In the present embodiment, the touch component may be a self-capacitance touch component. One of the at least two touch electrodes 411 receives touch signals, and then transmits the touch signals to a corresponding touch chip 43 by the corresponding touch wire 42.

In the present embodiment, an area of any one of the at least two touch electrodes 411 may range from 9 mm² to 100 mm². Sizes of the at least two touch electrodes 411 may be decided according to a specific product, and are not limited here.

Please refer to FIG. 4, each of the at least two touch electrode layers 41 further includes a touch node 412, and touch node 412 corresponds to one of the at least two first recesses 24 or/and the electrode connector 14.

A plurality of first intervals L1 between two adjacent electrical connectors 14 are equal in a first direction of the display panel 100, and a plurality of second intervals L2 between adjacent electrical connectors 14 are equal in a second direction of the display panel 100. Specifically, the first direction and the second direction may be referred to FIG. 4.

In the present embodiment, the first intervals L1 and the second intervals L2 are not equal.

In the present embodiment, the first intervals L1 may range from 1.4 mm to 1.6 mm, and the second intervals L2 may range from 1.3 mm to 1.5 mm.

When the first intervals L1 are 1.488 mm and the second intervals L2 are 1.341 mm, the electrical connectors 14 are evenly disposed. Therefore, not only can the touch wire 42 be disposed normally, but also supporting structures of the display panel can correspond to the intervals of the display panel 100.

The present embodiment further provides a display module, including the above display panel, and a polarizer layer and a cover plate layer, which are disposed on the display panel. A working principle of the display module is similar to or same as that of the display panel, and is not described here.

The present disclosure provides a display panel and a display module, including a first base plate and a second base plate disposed opposite to the first base plate. The first base plate includes a first substrate, a driving circuit layer, a first common electrode layer, and a plurality of electrical connectors. The second base plate includes a second substrate and a second common electrode layer. The display panel further includes a touch component including a touch electrode layer and a touch wire. The touch electrode layer is disposed between the second substrate and the second common electrode layer, the touch wire is disposed in the touch circuit layer, and the touch electrode layer is electrically connected to the touch wire by the touch electrode layer. In the present disclosure, the touch electrode layer is disposed on a light-emitting side of the display panel rather than on the driving circuit layer, and the touch wire is disposed on the driving circuit layer. Therefore, fewer metal wires are disposed on the light-emitting side, an amount of ambient light being reflected is reduced, and display effect of the display panel is improved.

It should be noted that many changes and modifications to the described embodiment can be carried out by those skilled in the art, and all such changes and modifications are intended to be included within the scope of the appended claims.

1. A display panel, comprising a first base plate, a second base plate disposed opposite to the first base plate, and a liquid crystal layer disposed between the first base plate and the second base plate;
wherein the first base plate comprises a first substrate, a driving circuit layer disposed on the first substrate, and a first common electrode layer and a plurality of electrical connectors which are disposed on the driving circuit layer;
the second base plate comprises a second substrate and a second common electrode layer disposed on the second substrate;
the display panel further comprises a touch component, the touch component comprises a touch electrode layer disposed between the second substrate and the second common electrode layer and a touch wire disposed in the driving circuit layer, and the touch electrode layer is electrically connected to the touch wire by the electrical connectors; and
each of the electrical connectors comprises a first connector and a second connector disposed on a surface of the first connector, the first connector is a conductive material, and the second connector is an insulating material.

2. The display panel of claim 1, wherein the driving circuit layer comprises a gate layer disposed on the first substrate and a source/drain layer disposed on the gate layer; and
the touch wire and at least one of the gate layer or the source/drain layer are disposed on a same layer.

3. (canceled)

4. The display panel of claim 1, wherein the second substrate comprises at least two first recesses, one of the at least two first recesses corresponds to one of the electrical connectors, the at least two first recesses penetrate the second common electrode layer, and an insulating layer is disposed between the second common electrode layer and the touch electrode layer, thereby exposing a portion of the touch electrode layer; and
the electrical connectors are electrically connected to the touch electrode layer by the at least two first recesses.

5. The display panel of claim 4, wherein a number of the at least two first recesses is less than or equal to a number of the electrical connectors.

6. The display panel of claim 4, wherein the display panel further comprises a color filter layer disposed in the first base plate or in the second base plate; and
when the color filter layer is disposed in the second base plate, the color filter layer is disposed on a first side of the touch electrode layer near the second common electrode layer or on a second side of the touch electrode layer away from the second common electrode layer.

7. The display panel of claim 1, wherein each of the electrical connectors comprises a first connector which is a conductive material; and
the touch electrode layer is electrically connected to the touch wire in the driving circuit layer by the first connector.

8. (canceled)

9. The display panel of claim 1, wherein the touch electrode layer comprises at least two touch electrodes distributed in an array manner, and an area of any one of the at least two touch electrodes ranges from 9 mm² to 100 mm².

10. The display panel of claim 1, wherein a plurality of first intervals between two adjacent electrical connectors are equal in a first direction of the display panel;
a plurality of second intervals between two adjacent electrical connectors are equal in a second direction of the display panel; and
the first intervals and the second intervals are not equal.

11. A display module, comprising a display panel, wherein the display panel comprises a first base plate, a second base plate disposed opposite to the first base plate, and a liquid crystal layer disposed between the first base plate and the second base plate;
wherein the first base plate comprises a first substrate, a driving circuit layer disposed on the first substrate, and a first common electrode layer and a plurality of electrical connectors which are disposed on the driving circuit layer;
the second base plate comprises a second substrate and a second common electrode layer disposed on the second substrate;
the display panel further comprises a touch component, the touch component comprises a touch electrode layer disposed between the second substrate and the second common electrode layer and a touch wire disposed in the driving circuit layer, and the touch electrode layer is electrically connected to the touch wire by the electrical connectors; and
each of the electrical connectors comprises a first connector and a second connector disposed on a surface of the first connector, the first connector is a conductive material, and the second connector is an insulating material.

12. The display module of claim 11, wherein the driving circuit layer comprises a gate layer disposed on the first substrate and a source/drain layer disposed on the gate layer; and
the touch wire and at least one of the gate layer or the source/drain layer are disposed on a same layer.

13. (canceled)

14. The display module of claim 11, wherein the second substrate comprises at least two first recesses, one of the at least two first recesses corresponds to one of the electrical connectors, the at least two first recesses penetrate the second common electrode layer, and an insulating layer is disposed between the second common electrode layer and the touch electrode layer, thereby exposing a portion of the touch electrode layer; and
the electrical connectors are electrically connected to the touch electrode layer by the at least two first recesses.

15. The display module of claim 14, wherein a number of the at least two first recesses is less than or equal to a number of the electrical connectors.

16. The display module of claim 14, wherein the display panel further comprises a color filter layer disposed in the first base plate or in the second base plate; and
when the color filter layer is disposed in the second base plate, the color filter layer is disposed on a first side of the touch electrode layer near the second common electrode layer or on a second side of the touch electrode layer away from the second common electrode layer.

17. The display module of claim 11, wherein each of the electrical connectors comprises a first connector which is a conductive material; and
the touch electrode layer is electrically connected to the touch wire in the driving circuit layer by the first connector.

18. (canceled)

19. The display module of claim 11, wherein the touch electrode layer comprises at least two touch electrodes distributed in an array manner, and an area of any one of the at least two touch electrodes ranges from 9 mm² to 100 mm².

20. The display module of claim 11, wherein a plurality of first intervals between two adjacent electrical connectors are equal in a first direction of the display panel;
a plurality of second intervals between two adjacent electrical connectors are equal in a second direction of the display panel; and
the first intervals and the second intervals are not equal.
